(19) United States
(12) Patent Application Publication
(10) Pub. No.: US 2021/0116140 A1
(43) Pub. Date: Apr. 22, 2021

(54) METHOD AND SYSTEM FOR CONFIGURING HVAC SYSTEMS

(71) Applicant: ERIC V DICKINSON, HIGHPOINT, NC (US)

(72) Inventor: ERIC V DICKINSON, HIGHPOINT, NC (US)

(21) Appl. No.: 16/914,381

(22) Filed: Dec. 26, 2020

Related U.S. Application Data
(60) Provisional application No. 62/886,266, filed on Aug. 13, 2019.

(51) Int. Cl. F24F 11/46; F24F 11/00; F24F 11/54; F24F 11/56; F24F 11/64; F24F 11/65; F24F 11/72; F24F 13/04; F24F 13/22; F25B 30/02; G05B 15/02

(52) U.S. Cl. CPC F24F 11/46; F24F 11/0008; F24F 11/54; F24F 11/56; F24F 11/64; F24F 2110/10; F24F 11/72; F24F 13/04; F24F 13/22; F25B 30/02; G05B 15/02; F24F 11/65

(57) ABSTRACT

Described herein is an improved HVAC system and method of configuring an HVAC system for cost-effective installation and energy efficient operation for multiple unit residential buildings. In one example embodiment, a mechanical room is sized to simultaneously house most of the HVAC equipment but to also advantageously operate as the HVAC system's air mixing chamber for a wall-mounted temperature and humidity conditioning unit and a blower assembly, based on maximum heating and cooling loads and the minimally required air flow requirement for a defined living space. This advantage allows for elimination of one or more mechanical plenums for air mixing space as well as flexibility in locating HVAC components in the space provided.

### CLAIM OF PRIORITY

This application claims priority to and the benefit of U.S. Provisional Application with Ser. No. 62/886,266, filed on Aug. 13, 2019 with the same title, the entirety of which is herein incorporated by reference.

### FIELD OF THE INVENTION

The inventive concept relates generally to HVAC (heating ventilation air conditioning) systems for residential and commercial environments.

### BACKGROUND

While various sources of heated or cooled air exist, a predominant system produces forced air heating or cooling using a refrigeration cycle. This normally requires one component (e.g., condenser coil, fan, and compressor) placed outside the air-conditioned space and therefore exposed to outdoor atmospheric air, and another component with an evaporator coil, fan and a metering device that delivers conditioned air to the space. Typical heat pump systems, as well as other equipment, including gas furnaces, require a determined amount of airflow through the heat exchanger in order to ensure proper operation. For example, a typical heat pump system requires approximately 400 Cubic Feet Per Minute (CFM) of air flow per ton of heating/cooling across the heat exchanger, which also translates to about 12000 BTUs (British Thermal Units) of a heating/cooling load. In these systems, another standard rule is you need about 1 ton of air heating/cooling load per 600 square feet of living space which is about 12000 BTUs. The theory behind a heating and cooling system using a refrigerant is to remove sensible and latent heat from a conditioned space. Sensible heat is the ambient air temperature and latent heat is basically a measurement of the amount of humidity in the form of energy. The sensible/latent ratio within a condition space changes based on exterior weather conditions as well as indoor loads such as lighting, people, cooking and something as simple as running a dishwasher. Most HVAC manufacturers design their components to deliver a sensible/latent ratio of about 70/30, give or take based on 400 CFM of airflow across the evaporator coil. All thermostats that are in cooling mode operate based on real time sensible loads. Therefore, even if an HVAC system is design per ACCA specifications, the resultant HVAC system is only properly sized a few days out of the year at best, thereby requiring a back-up dehumidifier to ensure the HVAC properly dehumidifies the conditioned space (which increases cost of the installation and energy operating costs of the system for the resident).

Due to the introduction of the energy code and its subsequent and recurring updates, structures by law must now meet tighter and tighter standards for how “airtight” a living or working space must be. In making structures more airtight, the law of unintended consequences has created a huge problem in the building industry. They have made the sensible/latent ratios less consistent, as well as lowering run times of HVAC equipment. You can not remove latent heat with out passing air across an evaporator coil at a set CFM rate. Another related problem this has caused, due to reduced run time, is not meeting the number of air changes needed per hour set forth by the energy code. The HVAC equipment industry has tried to solve the problem with variable speed air handlers that modulate air flow across the coil based on real time latent loads, which in turn reduces the air changes per hour even further. What we are seeing throughout the south east is that this type of HVAC system design is causing major mold and mildew problems. Lowering the humidity (latent heat) output into the structure is irrelevant if you can not move the required volume of air throughout the structure.

As building energy codes have become more restrictive (increased insulation and reduced air infiltration), the heating and cooling loads have been dramatically reduced in structures and volumes of living spaces. However, the airflow requirements for air exchanges, which are typically based upon the volume in the structure, have not changed. This situation creates a dilemma for the HVAC designer as they must choose to either: 1) meet the code requirements for heating and cooling loads with AHRI rated equipment and be deficient in meeting air flow requirements per ACCA Standards and ASHRAE 62.1 and ASHRAE 62.2; or 2) meet the air flow requirements and over size equipment (i.e., install equipment rated for high performance requirements), which results in short cycling (or the constant turning on and off of the equipment) . This short cycling can: 1) reduce the life expectancy of equipment, 2) increase humidity levels (drives down latent loading capacity for the volume of living space) within the structure which can result in increased energy consumption due to lower cooling temperatures in order to keep the occupants comfortable, and 3) create environments that increase the probability of mold growth.

Therefore, there currently exists a need in the market for a method and a system for configuring HVAC systems that meet both the cooling and heating loads, air flow requirements, which are cost effective to install and energy efficient to run while still meeting ever changing environment and regulatory requirements for air flow and heating and cooling loads in residential living spaces or smaller commercial spaces.

### SUMMARY OF THE INVENTION

The inventive concept described herein relates generally to an improved method and system for configuring HVAC systems to meet changing air flow and load requirements in fixed volume residential construction and small commercial spaces and with a limited selection of cooling and heat pump systems available or rated for such uses. The HVAC system described herein allows for the integration of multiple pieces of equipment in order to ensure proper airflow, air exchanges and proper sizing (heating and cooling loads) of equipment for applications that are outside of the typical performance characteristics of AHRI matched equipment. Finally, the HVAC system described herein provides the user more flexibility for meeting air flow requirements as well as heating and cooling load requirements in both residential and small commercial spaces.

One of the main challenges in designing and configuring HVAC systems today is the requirement that three (3) primary variables be maintained in balance in order to provide energy efficient conditioning of indoor air in a habitable space with a defined volume (or square footage). Only one of the three variables is constant in each design: airflow, which is based strictly on volume and needed hourly air changes. The other two variables are latent capacity and sensible capacity. These last two variables are not being properly maintained to acceptable levels by HVAC equipment currently available today and as such the HVAC equipment specified for a project may not perform as intended.

Some of the causes for being unable to easily and properly configure HVAC equipment and systems in habitable spaces today is that the available HVAC components and equipment are ineffective, or are rated for specific BTU loads with specific air flow requirements to meet the thermodynamic properties of the refrigerant used in the system, in addressing the everchanging energy performance codes and regulations for smaller living and working spaces and spaces that have lower infiltration levels and walls with higher insulative R values. Infiltration, or the amount of unconditioned air entering a thermal envelope, has always been a variable that has kept load design and airflow design within manageable and consistent ratios in terms of thermal transfer (heating and cooling) and air flow. Achieving more energy efficient HVAC systems to meet new and stricter code requirements are causing major gaps between efficient and accurately specified HVAC designs and properly sized equipment (and appropriately rated equipment for the specified use) versus what HVAC equipment is currently available to meet these new demands.

An advantageous application for the improved HVAC system and method of configuring an HVAC system is for apartment houses, townhomes, condominiums and smaller commercial working spaces or work spaces with lower occupancy during most of its use (and only experiencing short bursts of high occupancy during certain times in a week). These structures typically have reduced surface area or volumes exposed to the outdoors. This reduced surface area creates a situation that lowers the HVAC loads (heat loss/heat gain) due to the significantly reduced surface (such as outer facing walls) for thermal transfer for interior units but may present challenges for the exterior units that may have the same living/working space and have more exterior facing walls. For example, an interior apartment or condominium unit may have only one exposed surface to the outdoors, hence the heat gain/heat loss requirements are much lower. The most significant thermal transfer (Sensible HVAC load) is on then on a single surface or exterior facing wall. There is little to no sensible HVAC loading at the floor, ceiling, party wall or entrance wall (in the case of a closed breezeway). However, the overall living space (or volume of living space) may be significant, therefore the overall heating and cooling loads may be relatively low (9,000 BTU/HR of heat transfer). However, due to the size of the living space, the unit may require 1,000 CFM of airflow in order to achieve the code requirements for air changes. This situation raises the percentage of latent load (dehumidification) capacity as a percentage of total load capacity (Total Load=latent load+sensible load).

Based upon the example above, the 9,000 BTU/HOUR of load (12,000 BTU/HOUR=1 ton of heating and cooling) would be addressed with a typical single stage heat pump unit that would only provide 300 Cubic Feet per Minute (CFM) of airflow. This is based upon a typical heat pump unit which is capable of approximately 400 CFM per ton of air flow. Given this scenario, and the fact that most manufacturers do not provide equipment that is rated less than 1.5 tons (or 18,000 BTUs), an alternate HVAC design is required to meet the higher airflow requirement for the above example.

In various embodiments disclosed herein the HVAC system would include an energy efficient blower as part of an air handler unit to be connected to either a ducted or ductless system in order to meet the air flow requirements and this would be coupled to or with a heating and/or cooling system that closely matches the living space's HVAC load in a mixing chamber. In one example embodiment, the mixing chamber is a mechanical room or closet or any other air mixing space that can house most of the HVAC equipment or alternatively can be a dedicated plenum. This HVAC design provides maximum flexibility for designers to meet the code requirements with increased energy efficiency in smaller living and working spaces, thereby improving occupant satisfaction and achieving reduced humidity levels. The equipment used for heating, cooling and dehumidification include any single or combination of the following temperature and humidity treatment apparatus (THLA), which may not be all-inclusive list: 1) single stage heat pumps, 2) two-stage heat pump units, 3) single head mini-split systems, 4) multiple head mini-split systems, 5) Packaged Terminal Air Conditioner (PTAC), which includes heat pump units and variants, 6) Vertical Terminal Air Conditioner (VTAC), which includes heat pump units and variants, 7) Variable Refrigerant Flow (VRF) multiple head HVAC systems, 8) Variable Refrigerant Volume (VRV) multiple head systems, 9) dehumidification units, 10) hydronic heating coils, and 11) hydronic cooling coils.

The various embodiments of HVAC system described herein will minimize energy consumption and increase occupant comfort by: 1) utilizing heat pumps and cooling equipment that is matched or rated more closely with design loads: 2) more closely meeting the airflow requirements for air quality in the defined volume of living space; and 3) reducing humidity levels within the structure or living space by incorporating one or more pieces of equipment to control and monitor heating and cooling loads as well as humidity levels. Finally, unlike current prior art HVAC systems and design methods that control the amount of air that flows across a cooling coil, the embodiments described herein mixes the air in a chamber or configured space in order to achieve the proper amount of air flow per code and that also meets code requirements for not oversizing equipment for a particular application. In a related embodiment, the system is configured to use a multi-head zones system in order to accommodate unique building orientations and changes to the load as the surroundings change (trees grow providing more shade, new buildings blocking the sun from hitting the building, etc.).

The various embodiments disclosed herein advantageously: 1) provide appropriate air flow for a given space based upon air change requirements; 2) facilitate proper sizing of the CPE (refrigerant circuit or thermal equipment) to meet calculated design loads; 3) improve performance and comfort due to both air flow and thermal capacity being more closely matched to design standards and code requirements; 4) facilitates introduction of supply air at a temperature higher than the condensation point which reduces the probability of condensation accumulating in the supply duct (which can lead to mold issues later); 5) reduce energy consumption by the CPE as intended by the ever changing and increasing demands of stringent energy codes; 6) improve humidity control and energy performance with variable refrigerant CPE systems; 7) assist in meeting the design requirements of smaller spaces and ever changing zoning demands; and 8) provide a system for replacement and retrofit applications that were initially installed with smaller, less efficient equipment that is no longer commercially available.

In one example embodiment, there is provided an HVAC system for a defined living space which generates the requisite air changes and temperature and humidity control for a volume of living space to be heated and cooled. The system includes a wall-mounted temperature and humidity level air treatment (THLA) apparatus configured to receive return and/or unconditioned air and designed to transmit conditioned or supply air and further designed to move air in the living space to achieve about a 75% sensible load and about a 25% latent load, wherein the wall-mounted THLA treatment apparatus selected is rated such that a short cycling condition does not occur which reduces the latent load capacity and increases humidity levels in the defined living space. The system also includes an air handling unit (AHU) comprising a blower and having an inlet for receiving return and/or unconditioned air and having an outlet for transmitting conditioned air via a duct, the AHU unit designed to move air in the defined living space at a defined air flow rate that is above an air flow rate of the THLA apparatus, wherein the AHU unit does not provide air flow over a cooled or heated coil housed within the AHU unit and wherein the defined air flow rate is calculated as a function of the volume of the living space. The system in addition includes a mechanical room configured to provide an air mixing space for filtered return and/or unconditioned air and configured to provide an area for housing the AHU and housing least a portion of the wall mounted THLA treatment apparatus, wherein the mechanical room is dimensioned to provide the air mixing space as a function of the defined or calculated air flow rate requirement in cubic feet per minute of the volume of the living space, the defined air flow rate being generated from variables that include a maximum heating load in BTU/hour, a maximum cooling load in BTU/hour and a calculated volume of the living space.

In a related embodiment the HVAC system further includes a controller adapted to be operatively coupled to and control the AHU unit and the wall mounted THLA treatment apparatus, the controller including a temperature sensor, an input-output device, a processor and a non-transitory memory device adapted to store one or more instructions to cause the processor to perform one or more actions, including operating the THLA apparatus and the AHU unit to maintain the 25% latent load capacity and the defined air flow for the volume of the living space.

In another example embodiment, there is provided a method of providing an HVAC system which generates the requisite air changes and temperature and humidity control for a defined living space, the defined living space being a volume of space to be heated and cooled. The method includes the steps of first generating a set of load calculations for the defined living space according to a set airflow level requirements in cubic feet per minute (CFM) and BTU loss per room of the defined living space; and then generating a total target heating load loss in BTU/hour and a total target cooling load loss in BTU/hour for the defined living space. In the next step there is selected at least one of a wall-mounted temperature and humidity level air treatment apparatus (THLA) adapted to move air in the defined living space and achieve about 75% sensible load and about 25% latent load, wherein the at least one of a wall-mounted THLA apparatus selected is rated such that a short cycling condition does not occur which reduces the latent load and increases humidity levels in the defined living space. In the following step, there is selected an air handler unit (AHU) comprising a blower and having an inlet for receiving return and/or unconditioned air and having an outlet for transmitting conditioned air, the AHU unit adapted to move air in the defined living space at a defined air flow rate that is above a rated airflow rate provided by the at least one THLA apparatus, wherein the AHU unit does not provide airflow over a cooled or heated coil housed within the AHU. The method also includes providing a mechanical room configured to provide an air mixing space for filtered return and/or unconditioned air and configured to provide an area for housing the AHU and housing least a portion of the wall-mounted THLA unit, wherein the mechanical room is dimensioned to provide the air mixing space as a function of a calculated air flow requirement in cubic feet per minute generated from variables that include maximum heating load in BTU/hour, maximum cooling load in BTU/hour and a floor area of living space.

In this example embodiment, the THLA unit includes a minisplit system using an inverter system adapted to generate an additional about 20% of BTU/hour on demand. The method also includes the step of controlling, or providing a controller adapted to be operatively coupled to and control, the AHU unit and the wall mounted THLA treatment apparatus, the controller including a temperature sensor, an input-output device, a processor and a non-transitory memory device adapted to store one or more instructions to cause the processor to perform one or more actions, including operating the THLA apparatus and the AHU unit to maintain the 25% latent load capacity and the defined air flow for the volume of the living space. Finally, a porous filter is included and located on the mechanical room near the air handler unit.

The inventive concept now will be described more fully hereinafter with reference to the accompanying drawings, which are intended to be read in conjunction with both this summary, the detailed description and any preferred and/or embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIG. 1 illustrates a prior art HVAC system.

FIG. 2 illustrates a schematic of a first example embodiment of an HVAC system according to the teachings of the inventive concept.

FIG. 3 illustrates an example floorplan, air flow calculations and an air changes per hour table, respectively, which include calculated air flow requirements in cubic feet per minute (CFM) for the illustrated living space of about 630 ft² having a defined maximum heating and cooling load requirements for an interior unit and an exterior unit.

FIG. 4 illustrates a schematic of a second example embodiment of an HVAC system according to the teachings of the inventive concept.

FIG. 5 illustrates a schematic of another embodiment of an HVAC system according to the teachings herein configured to provide emergency heating to a living space.

FIG. 6 illustrates a flowchart of describing the method of configuring HVAC system for a small volume of living or working space or for a retrofit application according to the teachings herein.

FIG. 6 illustrates a ASHRAE Psychrometric chart for air.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of the inventive concept provide for an improved HVAC system and method of configuring an HVAC system for cost-effective installation and energy efficient operation for multiple unit residential buildings and small commercial buildings. Following is a solution to provide a fixed amount of air based the constant cubic volume of space in the structure and a system to manipulate the load being delivered to the structure based on real time sensible/latent loads as this can be done at a fraction of the energy operating cost and with the same upfront installation cost of a conventional system. Currently, there is not an HVAC system that is being manufactured that is small enough to meet the current code guidelines for most multi-family apartment applications while reducing equipment and operating costs for the resident.

In one example embodiment, a mechanical room is sized to simultaneously house most of the HVAC equipment but to also operate as the HVAC system's air mixing chamber based on maximum heating and cooling loads and the minimally required air flow requirement for a volume of a defined living space. Before we provide a description of the prior art HVAC system and components, we will discuss some additional challenges and variables that HVAC design engineers face today so as to highlight the advantages of an improved HVAC system and a method of providing heating and cooling in a small living and work space in a cost effective and energy efficient manner. The teachings discussed thereafter will provide solutions to HVAC engineers in dealing with a number of design challenges including but not limited to changing and ever more restrictive code requirements, more air tight living spaces, more thermally insulated exterior walls and limited choices in cooling and heating components.

The habitable space is normally referred to as the Thermal Envelope. Thermal envelopes are getting extremely tight, requiring fresh air ventilation and reduced heating and cooling capacity to condition the habitable or working space. The construction industry calls this challenge Infiltration, or the amount of unconditioned air entering a thermal envelope, which has been a variable that has kept load design and airflow design within manageable and consistent ratios in terms of thermal transfer (heating and cooling) and air flow. Minimal code requirement applications when faced with high efficiency applications (closed cell foam, ICP walls, etc..) are causing problems for HVAC equipment manufacturers in trying to deliver adequate air flow with reduced thermal loads, particularly when current HVAC components are slowly becoming obsolete. Dealing with excessive infiltration or trying to meet new minimal code requirements so as to provide highly efficient HVAC systems will increase equipment run times that in turn will change or offset the latent and sensible loads, respectively, being provided. Equipment manufacturer's design criteria have been based on prior code requirements or current efficiency applications. However, when the code requirement or application is changed to address a high efficiency thermal envelope (tighter air space through improved windows; exterior walls with improved R factor; etc. . . ) the same HVAC equipment is not capable of maintaining the same air flow design criteria which results in potentially specifying or producing over-sized (or over rated) equipment in terms of thermal transfer. Oversized HVAC equipment leads to short cycling (continuous on/off operation) and elevated latent (humidity) levels within the conditioned area as well as excessive wear on the HVAC equipment and elevated operating costs.

Simply put, HVAC equipment manufacturers have failed to adapt their HVAC components and equipment to maintain an acceptable balance of sensible and latent loads based on a fixed air flow amount directly related to thermal capacity. Manufacturers are instead relying on variable speed motors to adjust airflow with thermal capacity, which in turn is solving sensible load problems but amplifying latent load problems. Sensible loads are measured at the thermostat in ambient degrees of Fahrenheit which also control HVAC equipment operation. However, latent load or humidity are typically not controlled or measured by the thermostat and metering equipment that does monitors humidity and sensible ambient temperature is typically ineffective and creates an internal system clash between two devices or meters. With the building industry moving toward more efficient thermal envelopes affecting sensible and latent loads, we are finding that new highly efficient building envelopes require thermal loads that are significantly less than 18,000 BTU/Hr. In contrast, the smallest conventional split heat pump systems typically available are 1.5-ton systems (18,000 BTU/Hr.), hence these components and systems are grossly oversized for the intended application and the housing in one mechanical structure of the heating and/or cooling coils with the blower assembly also reduces design flexibility as these units already come pre-package into one installable unit.

The various embodiments disclosed herein provide a solution involving three (3) primary components for the main HVAC systems with an additional component number being optional (depending on the application): 1) Refrigerant Circuit Equipment (condenser, evaporator and compressor); 2) the Blower Assembly; and 3) the Duct System. The fourth is a Dehumidifier (for single or two-stage equipment). In order for the HVAC engineer to use commercially available equipment and maintain design flexibility, which is required due to the wide range of design applications abundant in the industry, segregating components 1 and 2 is a high priority in configuring the improved HVAC system. By segregating the refrigerant circuit equipment (RCE or CPE) it allows for the airflow design to be based on volume and needed air changes and allows the thermal load to be designed based on CPE equipment capacities. This is achieved by installing both the CPE equipment and the Blower Assembly in a common mixing chamber, which as taught advantageously herein is the mechanical room or closet, but purposely not locating the blower assembly with respect with the CPE equipment such that air flows over any cooling/heating coils. Hence, not only do you now house such equipment in one place, but the mechanical room advantageously operates as the mixing chamber for the CPE and the blower. This reduces component costs (one less mechanical plenum) and also greatly increases the flexibility of equipment selection and in turn lowers construction costs by simplifying future equipment production. In retrofit applications, since the mechanical room serves as the mixing chamber, there is no need to reconfigure mechanical connecting structures or plenums where space may be a problem.

With respect to Refrigerant Circuit Equipment, various choices of equipment are readily available in the market at this time, but the designated installation application will need to be slightly altered. This can be done without compromising the design capacity output. In a mini-split application, the improved HVAC design complements the existing variable refrigerant and humidity control equipment capabilities. With respect to the Blower Assembly such component is readily available in the market to deliver the designated airflow. With this improved design the need for advanced technology, such as numerous sensors and controllable vent louvers, is desirable but not required. By segregating the CPE equipment from the blower, you now have the flexibility to manufacture one blower assembly to accommodate all applications needed up to a 5-ton load with a single piece of equipment. A high efficiency ECM motor can be installed with a squirrel cage and housing and be programmed for a specific airflow and static pressure.

With respect to the duct system coupled to and from the mechanical room or closet such would not differ from any conventional system used today. The duct system would still need to be properly designed, sealed and installed to maintain expected design criteria. If properly designed for a low-pressure application, the system could provide greater energy efficiency. As described hereinafter, the dimensions of the mixing chamber or the mechanical room/closet will be dictated by the air flow and loading requirements of the habitable or working space but the tools for such are described below and are known to skilled HVAC engineers.

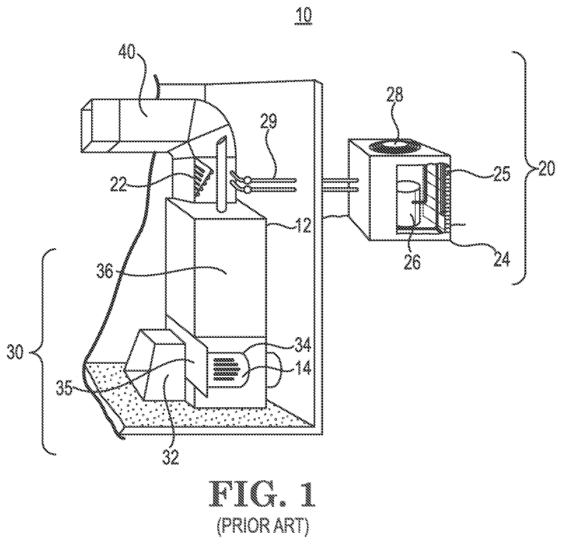

Referring to the figures, FIG. 1 illustrates a traditional HVAC system 10 including air conditioner equipment 20 and a gas forced air furnace equipment 30. AC equipment 20 includes an evaporator coil 22 that sits on top of furnace 12 and is the main component that cools air inside a home as furnace blower 14 passes air across evaporator coil 22. During this process, the air cools as it comes in contact with the cold coil and heat transfers from the air to the refrigerant. AC equipment also includes a condenser coil 25 which cools by removing heat from the refrigerant and is located in the outdoor condenser unit 24. Condenser unit 24 houses a compressor 26 which is an apparatus that is used to supply air or other gas at increased pressure. Condenser unit 24 also includes a fan 28 which creates a current of air to remove heat from the refrigerant. A refrigerant filled tube 29 then circulates refrigerant between outdoor condenser unit 24 and indoor evaporator coil 22.

Referring again to FIG. 1, HVAC system 10 uses gas forced air furnace equipment 30 to heat the living space by using air received from the various room via return air duct 32 which is a duct carrying air from a conditioned space (apartment or house) to a mixing air duct or plenum unit 34. Interposed between the return air duct 32 and plenum 34 is a porous filter 35 for removing impurities or solid particles from the air that passes through it. Blower 14 then creates a current of air up through an air handling unit (AHU) 36 which is used to condition and circulate air as part of a heating, ventilating, and air-conditioning (HVAC) system 10. An air handler is usually a large metal box containing a blower, heating or cooling elements, filter racks or chambers, sound attenuators, and dampers. Air handlers usually connect to a ductwork ventilation system 40 (or air supply duct) that distributes the conditioned air through the building and returns it to the AHU. Air supply duct 40 carries conditioned air from air supply units to room diffusers or grilles.

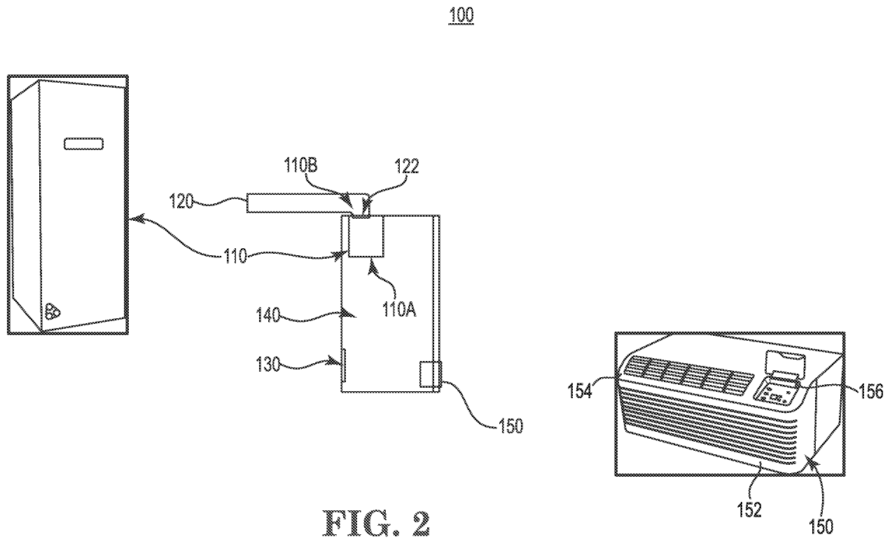

Referring now to FIG. 2 there is illustrated a schematic of one example embodiment of an improved HVAC system 100 using the teachings herein to configure and build a cost-effective and energy efficient HVAC system designed for each habitable unit of a multiple unit building or a small standalone working or living space (or a retrofit for same). In this example embodiment of HVAC system 100 configured for a living space, there is included an air handling unit (AHU) 110 equipped with a blower (not shown) having an inlet 110A for receiving return and/or unconditioned ventilation air and an outlet 110B for transmitting conditioned air through a duct 120. In this example embodiment, the AHU unit is a Goodman AVPTC24B14A with a no coil, heat kit and ECM motor. System 100 also includes a wall mounted temperature and humidity level air treatment (THLA) apparatus 150, which in this example embodiment is a PTAC (Packaged Terminal Air Conditioner), that is configured to receive return air and to transmit out conditioned (or supply) air. PTAC 150 includes a front air intake 152, an output air vent 154 providing conditioned air and a controller unit 156 with a display and an input unit or GUI (general user interface) for programming by a user. In one example embodiment, controller unit 156 includes an Amana Digismart display normally associated with an Amana-brand PTAC unit. PTAC 150 is partially protruding into a room (front end into mechanical room or mixing chamber 140) while a rear portion protrudes into the exterior for the air to air heat exchange. In a related embodiment, other THLA units such as a mini-split can be substituted for the PTAC/PTC 150.

In this example embodiment, system 100 further includes an optional porous filter 130 configured to filter unconditioned (or return) air coming from another room or area is also included. As part of system 100 a mechanical room 140 is provided which advantageously operates both as an air mixing space for filtered return (and/or unconditioned) air and as an area for housing AHU 110 and a portion of the THLA unit 150. PTAC 150 is partially protruding into a room (front end) while a rear portion protrudes or is partially housed by mechanical room 140. Mechanical room 140 is dimensioned to provide the air mixing space needed by HVAC system 100, to operate properly, as a function of a calculated air flow requirement in cubic feet per minute generated from variables that include maximum heating load in BTU/hour, maximum cooling load in BTU/hour and a volume or a floor area of living space. In this example embodiment, mechanical room 140 has 8-9 feet tall/height by 4 feet wide by 4 feet deep, in floor dimension (and associated volume) for housing the components of HVAC system 100 but also serves as the air mixing space or chamber for HVAC system 100, thereby eliminating the need for a separate physical plenum (coupling the CPE and the blower together). In a related embodiment, an optional radiation damper 122 is included and coupled to duct 120.

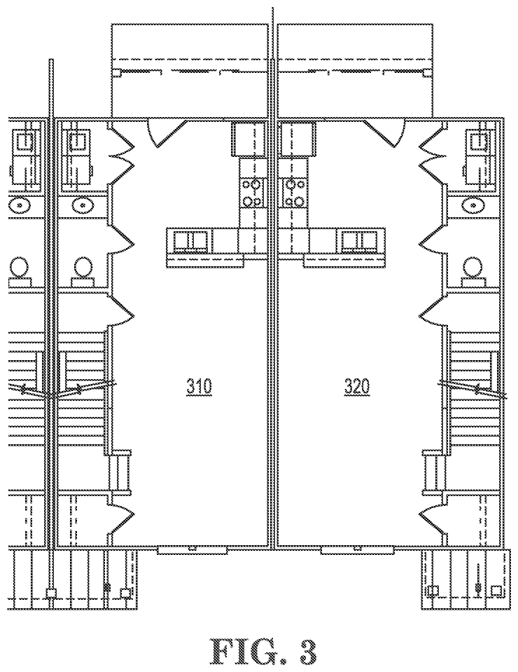

Referring now to FIG. 3 and the Appendix (2 pages), there is illustrated an example floorplan, air flow calculations (Appendix) and an air changes per hour table (Appendix), respectively, which include calculated air flow requirements in cubic feet per minute (CFM) for the illustrated living space of about 630 ft² having a defined maximum heating and cooling load requirements for an interior unit and an exterior unit. Note that in the Appendix the Duct Sizing analysis illustrates differing maximum heating and maximum cooling loads depending on whether you are configuring the HVAC system for the interior townhouse unit 310 (left one) or exterior townhouse unit 320 (right one). The Appendix provides an example for the living space of Fog. 3 of calculated air flow requirements in cubic feet per minute (CFM) for living spaces 310 and 320 having a general volume of 5615 cubic feet which is equivalent to a floor space of about 630 square feet. In this example, a required air flow is then calculated for this space by using the table in the Appendix of six (6) air flow changes per hour resulting at a minimum required air flow of about 562 CFM (i.e., (air changes per hour X volume of area)/60 minutes). Based upon the air flow and calculated loads in FIG. 3, a typical heat pump system, rated at 1.5 tons (approximately 18,000 BTU) of nominal cooling would be used. By way of example, and using the teachings of the present inventive concept, the larger air handling equipment can be used if the air mixing chamber or space is configured to handle the output or supply air but such equipment would then exceed the code requirements by about 29% in the extreme case for the exterior unit (12,799 BTU/HR) for cooling load and about 65% in the heating case (6,270 BTU/HR). It would also exceed code for the interior unit as well. In this example, the air handler is a standard heat pump having 400 CFM of air moving across a cooling coil. Given the stated heating/cooling loading requirements, the Return Face Opening in square feet and square inches is calculated to arrive at a square opening of about 16″×16″ (15.78 inches). With a given volume of 562 CFM and a Return Velocity of 325 CFM (kept low to make sure system 100 is quiet (higher air flow velocities create more noise) and to also mix the air at a low velocity), this results in a minimum size space for mixing the air of 36 inches by 32 inches, with standard closets having a dimension of 40 inches by 37 inches.

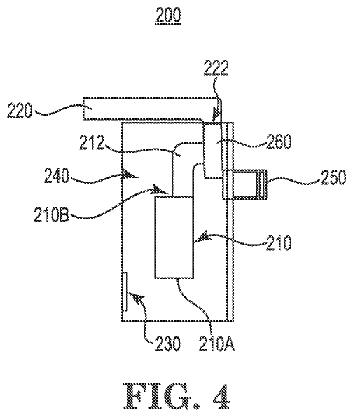

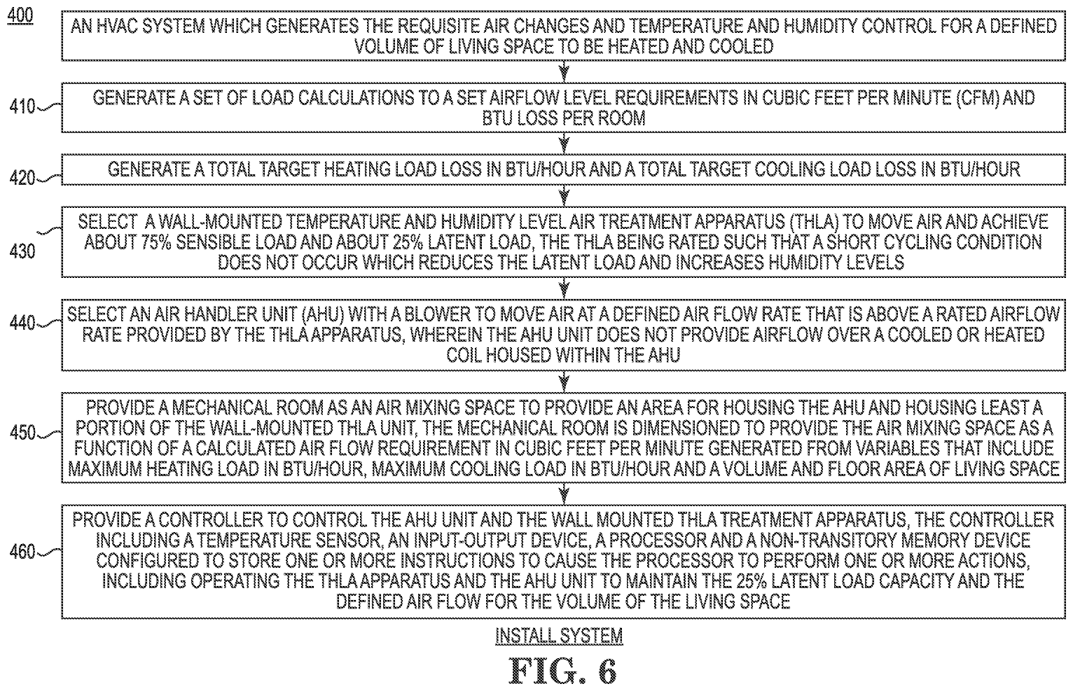

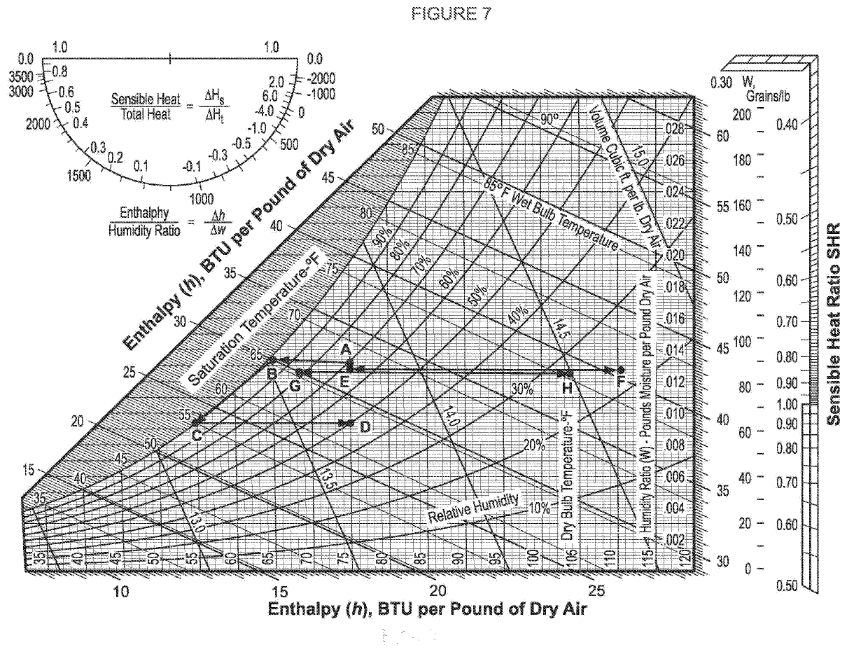

Hence in living units 310 and 320 of FIG. 3, mechanical room 140 of FIG. 2 (or mechanical room 240 of FIG. 4) is then configured to provide the at least 249.01 in² mixing area for the HVAC equipment to be used and the user would not need a mechanical plenum of equivalent size to accommodate the air mixing space needs. Referring briefly to FIG. 6, there is described a design process and steps for arriving at the correct air mixing space that matches the air handling equipment being used. The ACCA duct calculation tool would also be used to arrive at the duct dimensions, which are then converted to the mechanical room dimensions used in the present inventive concept to eliminate the mechanical plenum. In one example embodiment, where a mini-split is used to receive the 16-inch×16-inch air flow, normally a 36-inch×25 inch plenum or duct would have to be configured to direct air flow to the mini-split unit. Therefore in configuring the mechanical room, factors to be considered in directing the air would be: 1) location of the mini-split or PTAC unit in the room; 2) the direction of the vanes on the mini-split; and 3) the direction of the return air for the return grille along with the size or volume of the living space to treated.

Prior art systems would normally use a duct or plenum that would provide this mixing area or space but with the present inventive concept, mechanical room 140 (or room 240) is configured to match this air mixing area thereby eliminating the plenum or duct and instead using the same room that houses the HVAC components to advantageously also operate as the air mixing space required by HVAC system 100. Note that in the various embodiments disclosed herein the air handling units do not use an evaporator cooling coil, as is found in prior art systems, as such is provided by the THLA devices. For example, the mini-split includes an evaporator cooling coil with a variable speed blower while the PTAC unit provides a basic on/off blower for cooling/heating.

A more detailed discussion of the disclosed mixing chamber/mechanical room 140 (or 240) will highlight the advantages of the HVAC system described herein. In our current townhomes or smaller living or working spaces, there is too high of a return velocity hence this has to be managed or the system will be too loud for the resident or occupant. There is a need to double the size of the return in order to obtain more of a laminar flow instead of turbulent flow on the return. There is also a need to introduce air at a maximum air speed at the top of the mini-split head that is a maximum of 80% (50% or less is probably best) of the inlet air speed of the slowest setting on the mini-split head. This increases the dwell time of the air and maximizes dehumidification. In our various applications, the slowest speed is 215 CFM. The inlet is approximately 32 in. ×4 in (2.6 ft. ×0.33 ft.)=128 Sq.-In (0.881 SF (square feet)). This would provide an air velocity prior to the face coil at 215 CFM×50%=107.5 CFM→(107.5 Cubic Feet/Min)×(1/0.881 SQ Ft)=122 Feet/Min of velocity.

Based upon this calculation and 600 CFM, the closest would have to be a minimum of (600 Cu Ft/Min)/(122 Ft/Min)=4.9 SF (square feet). Our mechanical room closet is 4 ft.×4 ft. or 16 SF (square feet).

Based upon the above area, the theoretical flow at the coil would be far less than our maximum allowable, which in turn maximizes the heat transfer at the mini-split head. Furthermore, since the air at the mini-split head, especially in humid environments, mixes with warmer air, it should consistently be above the dew point except at the coil. This would eliminate condensation in the duct work.

Hence, 600 CFM at 72 degrees—mixes with 215 CFM at 37 degrees (minimum mini split speed and lowest temperature for dehumidification) +385 CFM at 72 degrees=59 degrees at 600 CFM.

Further, 600 CFM at 72 degrees—mixes with 380 CFM at 43 degrees (maximum mini split speed and recovery temperature) +220 CFM at 72 degrees=53.6 degrees at 600 CFM.

From the attached ASHRAE Psychrometric chart for air in FIG. 7, it is evident that it is important in humid climates to keep the temperature above 50 degrees to eliminate condensation in other HVAC components (Source—ASHRAE).

The flow in our mixing chamber/mechanical room is different (or opposite) of the standard duct design. In our teachings, a higher velocity of air is the goal in the space to create a turbulent environment and mix the air but you also have to consider that a high velocity air system is normally very noisy. The HVAC systems described herein are opposite in operation and theory to prior art systems. The goal is to slow the air down so that it is a laminar flow and the air has a longer contact period with the coil for heat transfer. Further, we do not want to starve the inlet of the mini-split head for air.

Referring now to FIG. 4, there is illustrated a second embodiment of an HVAC system 200 using a different temperature and humidity level air treatment (THLA) device. In this example embodiment of HVAC system 100 configured for a living or working space there is included an air handling unit (AHU, such as the Goodman described earlier) 210 having an inlet 210A for receiving return air and an outlet 210B coupled to a duct 212 for transmitting conditioned air. System 200 also includes a temperature and humidity level air treatment (THLA) apparatus 250, which in this example embodiment is a wall mounted heat pump such as a minisplit, that is configured to receive unconditioned air and to transmit out conditioned air. As part of system 200, an optional porous filter 230 is included that is configured to filter return air coming from another room or area is also included. As part of system 200 a mechanical room 240 is provided which provides space for a separate (optional) mixing chamber 260 and operates as an air mixing space for filtered return air and provides an area for housing AHU 210 and for housing a portion of the THLA unit 250. The mixing chamber 260 is dimensioned to provide the air mixing space needed by HVAC system 200, so as to operate properly as a function of a calculated air flow requirement in cubic feet per minute, the dimensions being generated from variables that include maximum heating load in BTU/hour, maximum cooling load in BTU/hour and a floor area of living space. In this example embodiment, mechanical room 240 has 8-9 feet in height by 4 feet wide, 4 feet deep in floor dimension (and associated volume) for housing the components of HVAC system 200 and to duct the conditioned air directly into the mixing chamber. In a related example embodiment, an optional radiation damper 222 is included and coupled to duct 220.

In related example embodiments, mini-split systems with a dehumidification mode will also provide enhanced dehumidification for structures. This is particularly important in hot and humid environments. Mini-split systems also provide a wider range of HVAC load accommodation due to Variable Refrigerant technology (or inverter technology) that enables the system to run from 20% or less of capacity to 120% of capacity.

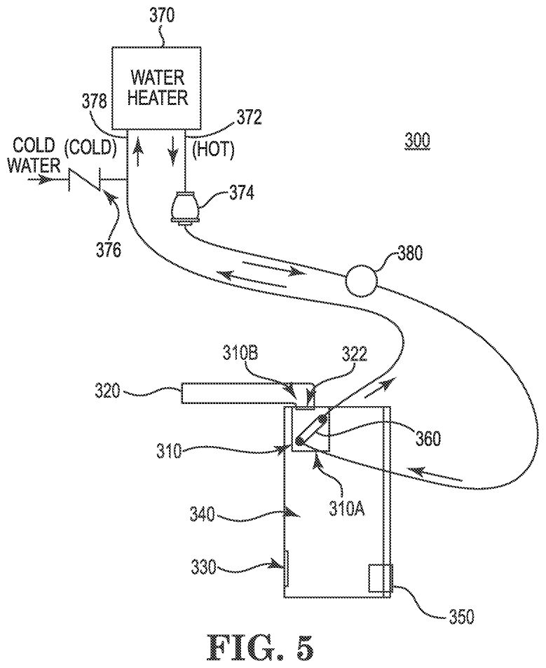

Referring now to FIG. 5 there is illustrated a schematic of one example embodiment of an improved HVAC system 300 configured to provide an emergency heating feature where there may be a temporary failure of the heat pump unit or heating source. In this example embodiment of HVAC system 300 (and similar to system 100) for a living space there is included an air handling unit (AHU) 310 equipped with a blower (not shown) having an inlet 310A for receiving return and/or unconditioned ventilation air and an outlet 310B (coupled to a duct 320) for transmitting conditioned air. System 300 also includes a wall mounted temperature and humidity level air treatment (THLA) apparatus 350, which in this example embodiment is a PTAC (Packaged Terminal Air Conditioner), that is configured to receive return air and to transmit out conditioned (or supply) air. Similar to PTAC 150, PTAC 350 includes a number of the same features and components. PTAC 350 is partially protruding into a room (front end) while a rear portion protrudes or is partially housed by a mechanical room 340. In a related embodiment, other THLA units such as a mini-split can be substituted for the PTAC/PTC 350. In this example embodiment, system 300 further includes an optional porous filter 130 configured to filter unconditioned (or return) air coming from another room or area is also included.

As part of system 300 mechanical room 140 (or room 240) is provided which advantageously operates both as an air mixing space or chamber for filtered return (and/or unconditioned) air and as an area for housing AHU 310 and a portion of the THLA unit 350. PTAC 350 is partially protruding into a room (with front end into mechanical room 240) while a rear portion protrudes into the exterior for air to air exchange. Mechanical room 340 is dimensioned to provide the air mixing space needed by HVAC system 300, to operate properly, as a function of a calculated air flow requirement in cubic feet per minute generated from variables that include maximum heating load in BTU/hour, maximum cooling load in BTU/hour and a volume or a floor area of living space. In this example embodiment, mechanical room 340 has 8-9 feet in height by 4 feet wide by 4 feet deep in floor and volume dimensions for housing the components of HVAC system 300 but also serves as the air mixing space or chamber for HVAC system 300, thereby eliminating the need for a separate physical plenum (coupling the CPE and the blower together). In a related embodiment, an optional radiation damper 322 is included and coupled to duct 320. As part of the emergency back-up or support heating system, when the THLA unit is temporarily in need of servicing or not functioning properly, system 300 is provided with a hydronic coil 360 in AHU310 that is coupled on a first end 361 to a hot water tube or pipe 372 fed by a water heater 370. A second end 363 of coil 360 is coupled a return water tube or pipe 378 after heat from hydronic coil 360 dissipates within AHU 310 and heated air is transmitted out to the rooms of the home via duct 320. Pipe 372 includes a pump 380 to pump hot water to coil 360 and a shutoff valve or check valve 374 while cool water flows back through pipe 378 which is connected to a cold-water supply through a valve 376.

Referring now to FIG. 6, there is described a method 400 of providing an HVAC system which generates the requisite air changes and temperature and humidity control for a defined living space, the defined living space being a volume of space to be heated and cooled. The method includes in the first step 410 of first generating a set of load calculations for the defined living space according to a set airflow level requirements in cubic feet per minute (CFM) and BTU loss per room of the defined living space. In step 420, generate a total target heating load in BTU/hour and a total target cooling load in BTU/hour for the defined living space. In the next step 430 there is selected at least one of a wall-mounted temperature and humidity level air treatment apparatus (THLA) adapted to move air in the defined living space and achieve about 75% sensible load and about 25% latent load, wherein the at least one of a wall-mounted THLA apparatus selected is rated such that a short cycling condition does not occur which reduces the latent load and increases humidity levels in the defined living space.

In the following step 440, there is selected an air handler unit (AHU) comprising a blower and having an inlet for receiving return and/or unconditioned air and having an outlet for transmitting conditioned air, the AHU unit adapted to move air in the defined living space at a defined air flow rate that is above a rated airflow rate provided by the at least one THLA apparatus, wherein the AHU unit does not provide airflow over a cooled or heated coil housed within the AHU. The method also includes step 450 of providing a mechanical room configured to provide an air mixing space for filtered return and/or unconditioned air and configured to provide an area for housing the AHU and housing least a portion of the wall-mounted THLA unit, wherein the mechanical room is dimensioned to provide the air mixing space as a function of a calculated air flow requirement in cubic feet per minute generated from variables that include maximum heating load in BTU/hour, maximum cooling load in BTU/hour and a floor area of living space.

In this example embodiment, the THLA unit includes a minisplit system using an inverter system adapted to generate an additional about 20% of BTU/hour on demand. The method also includes the step 460 of providing a controller adapted to be operatively coupled to and control the AHU unit and the wall mounted THLA treatment apparatus, the controller including a temperature sensor, an input-output device, a processor and a non-transitory memory device adapted to store one or more instructions to cause the processor to perform one or more actions, including operating the THLA apparatus and the AHU unit to maintain the 25% latent load capacity and the defined air flow for the volume of the living space. Finally, a porous filter is included and located on the mechanical room near the air handler unit.

The various aforementioned embodiments are configured for most smaller volume living and working spaces and provide a solution to meet both the heat loss/heat gain and provide the correct amount of air flow as required by code. The systems and methods described herein provide or generate an infinite combination of air flow and BTU input in order to meet code requirements for both air flow and heat loss/heat gain calculations, which is critical as the energy efficiency code requirement increase. For most applications, the air flow appears to remain constant, but the BTU input demands change based upon energy codes, geographic location, and exterior weather conditions. Due to the proper size of the heat loss/heat gain, the sensible cooling load is thereby properly sized and the latent cooling load can then dehumidify the living or working space more effectively due to the extended run times. Since the heat loss/heat gain is properly sized for a particular application, the heating and cooling systems needed can be smaller and thereby use less energy and cost less to operate. If more humidity is desired, a user may just set out a bowl of water or provide a portable humidifier or add a humidifier to the HVAC system with appropriate controls.

Although there may be prior art HVAC systems that appear to use minisplit devices working in conjunction with duct systems, the embodiments described herein are not typically connecting with conventional ductwork, as is prescribed in section 10 of the ACCA manual or as in Manuals J, D and S. Further, the HVAC systems described herein are not pressurizing with the minisplit device and specifically with a shelf surrounding the minisplit as proposed by some prior art systems. The HVAC systems described herein, in using minisplits or other THLA equipment, strive to have more dwell time around the coil and intentionally move air with a low velocity and laminar flow over the coil head and at a low pressure to ensure it is quiet and the THLA equipment work properly. Some of these prior art systems also do not account for number of air exchanges required in the particular space, the CFM running across the coil and the speed of air across the minisplit inlet. In trying to meet code requirements, most HVAC systems end up oversizing the equipment; air flow is not properly matched to the calculated load; there is lack of consistency in achieving temperature in these sized spaces; humidity in hot, humid environments is not properly managed and energy efficiency with right sized equipment is not achieved. a low pressure system with low velocities so the mini-split head would function properly. Another advantage to the HVAC systems described herein is that they do not require that 100% of the air in the living unit pass by the coil, hence there is no requirement to connect a duct to the mini-split head.

In summary, the above described systems and method allow for maximum design flexibility to meet air flow performance matched to code or designed requirements; heating and cooling loads matched to code or designed requirements; energy efficiency performance matched to design requirements; more better room to room temperature consistency and equipment selection for new construction and retrofit applications. Further, various of the above embodiments advantageously may also reduce the electrical load calculation for the living space.

The Appendix (2 pages) and the following patents are incorporated by reference in their entireties: U.S. Pat. Nos. 6,986,708; 8,255,087 and 10,072,856.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An HVAC system for a defined living space which generates the requisite air changes and temperature and humidity control for a volume of living space to be heated and cooled comprising:
a wall-mounted temperature and humidity level air treatment (THLA) apparatus adapted to receive return and/or unconditioned air and adapted to transmit conditioned or supply air and further adapted to move air in the living space to achieve about a 75% sensible load and about a 25% latent load, wherein the wall-mounted THLA treatment apparatus selected is rated such that a short cycling condition does not occur which reduces the latent load capacity and increases humidity levels in the defined living space;
an air handling unit (AHU) comprising a blower and having an inlet for receiving return and/or unconditioned air and having an outlet for transmitting conditioned air, the AHU unit adapted to move air in the defined living space at a defined air flow rate that is above an air flow rate of the THLA apparatus, wherein the AHU unit does not provide air flow over a cooled or heated coil housed within the AHU unit and wherein the defined air flow rate is calculated as a function of the volume of the living space; and
a mechanical room configured to provide an air mixing space for filtered return and/or unconditioned air and configured to provide an area for housing the AHU and housing least a portion of the wall mounted THLA treatment apparatus, wherein the mechanical room is dimensioned to provide the air mixing space as a function of the defined or calculated air flow rate requirement in cubic feet per minute of the volume of the living space, the defined air flow rate being generated from variables that include a maximum heating load in BTU/hour, a maximum cooling load in BTU/hour and a calculated volume of the living space.

2. The HVAC system of claim 1 further comprising a controller adapted to be operatively coupled to and control the AHU unit and the wall mounted THLA treatment apparatus, the controller including a temperature sensor, an input-output device, a processor and a non-transitory memory device adapted to store one or more instructions to cause the processor to perform one or more actions, including operating the THLA apparatus and the AHU unit to maintain the 25% latent load capacity and the defined air flow for the volume of the living space.

3. The HVAC system of claim 1, wherein the THLA unit includes a self-contained heating and air conditioning unit (SCHAC) selected from the group consisting of a Packaged Terminal Air Conditioner (PTAC), which includes heat pump units and variants, and a Vertical Terminal Air Conditioner (VTAC), which includes heat pump units and variants.

4. The HVAC system of claim 1, wherein the THLA unit is a single head mini-split system.

5. The HVAC system of claim 1, wherein the THLA unit is selected from the group consisting of single stage heat pumps, two-stage heat pump units and hydronic heating coils.

6. The HVAC system of claim 1, wherein the THLA unit is selected from the group consisting of Variable Refrigerant Flow (VRF) multiple head HVAC systems; Variable Refrigerant Volume (VRV) multiple head systems; dehumidification units; and hydronic cooling coils.

7. The HVAC system of claim 1, further comprising a porous filter configured to filter return air, the porous filter disposed adjacent the AHU.

8. The HVAC system of claim 1 further comprising a hydronic heating coil located within the air handler unit wherein the hydronic heating coil is operatively coupled to a water heater unit.

9. The HVAC system of claim 1 wherein the THLA unit is a multiple head minisplit system. 10, A method of providing an HVAC system which generates the requisite air changes and temperature and humidity control for a defined living space, the defined living space being a volume of space to be heated and cooled, the method comprising the steps of:
generating a set of load calculations for the defined living space according to a set airflow level requirements in cubic feet per minute (CFM) and BTU loss per room of the defined living space;
generating a total target heating load loss in BTU/hour and a total target cooling load loss in BTU/hour for the defined living space;
selecting at least one of a wall-mounted temperature and humidity level air treatment apparatus (THLA) adapted to move air in the defined living space and achieve about 75% sensible load and about 25% latent load, wherein the at least one of a wall-mounted THLA apparatus selected is rated such that a short cycling condition does not occur which reduces the latent load and increases humidity levels in the defined living space;
selecting an air handler unit (AHU) comprising a blower and having an inlet for receiving return and/or unconditioned air and having an outlet for transmitting conditioned air, the AHU unit adapted to move air in the defined living space at a defined air flow rate that is above a rated airflow rate provided by the at least one THLA apparatus, wherein the AHU unit does not provide airflow over a cooled or heated coil housed within the AHU; and
providing a mechanical room configured to provide an air mixing space for filtered return and/or unconditioned air and configured to provide an area for housing the AHU and housing least a portion of the wall-mounted THLA unit, wherein the mechanical room is dimensioned to provide the air mixing space as a function of a calculated air flow requirement in cubic feet per minute generated from variables that include maximum heating load in BTU/hour, maximum cooling load in BTU/hour and a floor area of living space.

11. The method of claim 10 wherein the THLA unit includes a minisplit system using an inverter system adapted to generate an additional about 20% of BTU/hour on demand.

12. The method of claim 10 further comprising the step of providing a controller adapted to be operatively coupled to and control the AHU unit and the wall mounted THLA treatment apparatus, the controller including a temperature sensor, an input-output device, a processor and a non-transitory memory device adapted to store one or more instructions to cause the processor to perform one or more actions, including operating the THLA apparatus and the AHU unit to maintain the 25% latent load capacity and the defined air flow for the volume of the living space.

13. The method of claim 10, wherein the THLA unit includes a self-contained heating and air conditioning unit (SCHAC) selected from the group consisting of a Packaged Terminal Air Conditioner (PTAC), which includes heat pump units and variants, and a Vertical Terminal Air Conditioner (VTAC), which includes heat pump units and variants.

14. The HVAC system of claim 10, wherein the THLA unit is a single head mini-split system.

15. The HVAC system of claim 10, wherein the THLA unit is selected from the group consisting of single stage heat pumps, two-stage heat pump units and hydronic heating coils.

16. The HVAC system of claim 10, wherein the THLA unit is selected from the group consisting of Variable Refrigerant Flow (VRF) multiple head HVAC systems; Variable Refrigerant Volume (VRV) multiple head systems; dehumidification units; and hydronic cooling coils.

17. The HVAC system of claim 10, further comprising the step of providing a porous filter configured to filter return air disposed adjacent the AHU.

18. The method of claim 11 further comprising a hydronic heating coil located within the air handler unit wherein the hydronic coil is operatively coupled to a water heater unit.

19. The method of claim 11 wherein the THLA unit includes multiple head mini split systems.

20. The method of claim 11 wherein the duct includes a radiation damper operatively coupled with the outlet of the AHU unit.
